(19) United States
(12) Patent Application Publication
(10) Pub. No.: US 2025/0239125 A1
(43) Pub. Date: Jul. 24, 2025

(54) COIN HANDLING SYSTEM AND COIN HANDLING METHOD

(71) Applicant: Glory Ltd., Himeji (JP)

(72) Inventor: Junji MASHIMO, Himeji (JP)

(73) Assignee: Glory Ltd., Himeji (JP)

(21) Appl. No.: 19/026,606

(22) Filed: Jan. 17, 2025

(30) Foreign Application Priority Data
Jan. 18, 2024 (JP) 2024-005878

(51) Int. Cl. G07D 11/36; G07D 11/14; G07D 11/34; G07D 11/60

(52) U.S. Cl. CPC G07D 11/36; G07D 11/34; G07D 11/60; G07D 11/14; G07D 2201/00; G07D 2211/00

(57) ABSTRACT

A coin handling system includes: a first apparatus configured to handle at least coins; a second apparatus configured to handle coins and be, by itself, unable to transmit coin information regarding coins handled by the second apparatus, to a banking server; and an output apparatus configured to output transaction identification information for identifying a coin transaction in the second apparatus, the second apparatus transmits the coin information and the transaction identification information outputted by the output apparatus, to the first apparatus, and when the first apparatus receives the coin information and the transaction identification information from the second apparatus, the first apparatus transmits the coin information and customer identification information for identifying a customer associated with the transaction identification information, to the banking server.

### CROSS-REFERENCE TO RELATED APPLICATION

This application is based on and claims priority under 35 USC § 119 to Japanese Patent Application No. 2024-005878 filed on Jan. 18, 2024, the disclosure of which is incorporated herein by reference in its entirety.

### BACKGROUND OF THE INVENTION

### Field of the Invention

The present invention relates to a coin handling system and a coin handling method.

### Description of the Background Art

Japanese Patent No. 5997947 describes a coin handling machine in which: a storage unit is able to also store therein media not associated with monetary amounts other than valuable media; when a medium other than coins recognized by a recognition unit is to be stored in the storage unit, whether or not the medium is a medium associated with a monetary amount is selected; and only when the medium to be stored in the storage unit is a medium associated with a monetary amount, information regarding the monetary amount of the medium is inputted by an input unit.

There are cases where it is desired to handle coins by an apparatus that cannot independently transmit coin information regarding coins handled by the apparatus to a banking server. In such a case, in order to transmit coin information to the banking server, it is necessary to make significant system modifications to enable the apparatus to communicate with the banking server.

An object of the present invention is to, when an apparatus that cannot independently transmit coin information regarding coins handled by the apparatus to a banking server is caused to handle coins, enable transmission of coin information to the banking server without having to make significant system modifications.

### SUMMARY OF THE INVENTION

To achieve this object, the present invention provides a coin handling system including: a first apparatus configured to handle at least coins; a second apparatus configured to handle coins and be, by itself, unable to transmit coin information regarding coins handled by the second apparatus, to a banking server; and an output apparatus configured to output transaction identification information for identifying a coin transaction in the second apparatus, wherein the second apparatus transmits the coin information and the transaction identification information outputted by the output apparatus, to the first apparatus, and when the first apparatus receives the coin information and the transaction identification information from the second apparatus, the first apparatus transmits the coin information and customer identification information for identifying a customer associated with the transaction identification information, to the banking server.

The first apparatus may include a first coin storage unit configured to store coins therein, the second apparatus may include a second coin storage unit configured to store coins therein, and the second coin storage unit may have a larger storage capacity than the first coin storage unit. In this case, the first coin storage unit may include a plurality of storage units configured to store therein coins of a plurality of dominations, respectively, the second coin storage unit may include a plurality of storage units configured to store therein coins of the plurality of dominations, respectively, and each storage unit of the second coin storage unit may have a larger storage capacity than the storage unit, of the first coin storage unit, configured to store therein coins of the same domination as in the each storage unit.

The output apparatus may be included in the first apparatus, the first apparatus may receive the customer identification information from the customer, and output the transaction identification information based on the customer identification information outputted by the output apparatus, to the customer, and the second apparatus may receive the transaction identification information from the customer. In this case, the first apparatus may control a printer to print the transaction identification information on a medium as an outputting of the transaction identification information to the customer, and the second apparatus receiving the transaction identification information from the customer may include the second apparatus reading the transaction identification information printed on the medium. In addition, the first apparatus may control a display unit to display the transaction identification information on the display unit as an outputting of the transaction identification information to the customer, and the second apparatus receiving the transaction identification information from the customer may include the second apparatus reading the transaction identification information displayed on a mobile terminal that has taken an image of the transaction identification information displayed on the display unit. Furthermore, the first apparatus may control a transmitter to transmit the transaction identification information to a mobile terminal as an outputting of the transaction identification information to the customer, and the second apparatus receiving the transaction identification information from the customer may include the second apparatus reading the transaction identification information displayed on the mobile terminal that has received the transaction identification information.

The output apparatus may be included in the second apparatus, the second apparatus may output the transaction identification information outputted by the output apparatus, to the customer, and the first apparatus may receive the customer identification information and the transaction identification information from the customer. In this case, the second apparatus may control a printer to print the transaction identification information on a medium as an outputting of the transaction identification information to the customer, and the first apparatus receiving the transaction identification information from the customer may include the first apparatus reading the transaction identification information printed on the medium. In addition, the second apparatus may control a display unit to display the transaction identification information on the display unit as an outputting of the transaction identification information to the customer, and the first apparatus receiving the transaction identification information from the customer may include the first apparatus reading the transaction identification information displayed on a mobile terminal that has taken an image of the transaction identification information displayed on the display unit. Furthermore, the second apparatus may control a transmitter to transmit the transaction identification information to a mobile terminal as an outputting of the transaction identification information to the customer, and the first apparatus receiving the transaction identification information from the customer may include the first apparatus reading the transaction identification information displayed on the mobile terminal that has received the transaction identification information.

The first apparatus may print a transaction statement regarding the transaction on a medium after transmitting the coin information and the customer identification information to the banking server.

The first apparatus may display a procedure for using the second apparatus. In this case, the first apparatus may display a transaction menu including a specific selection item indicating coin depositing in the second apparatus, and may display the procedure if the specific selection item is selected from the transaction menu. In addition, the first apparatus may display the procedure if the customer identification information indicates a corporation or self-employment. Furthermore, the first apparatus may display the procedure if the customer identification information does not indicate a general customer.

The first apparatus may further handle banknotes, acquire banknote information regarding banknotes handled by the first apparatus, and transmit the banknote information, the coin information, and the customer identification information to the banking server in association with each other.

The transaction identification information may be a geometric code and/or a character string code. In this case, the geometric code may be a QR code.

The present invention also provides a coin handling method in a coin handling system including a first apparatus configured to handle at least coins, a second apparatus configured to handle coins and be, by itself, unable to transmit coin information regarding coins handled by the second apparatus, to a banking server, and an acquisition apparatus configured to acquire transaction identification information for identifying a coin transaction in the second apparatus, the coin handling method including: second apparatus transmitting the coin information and the transaction identification information acquired by the acquisition apparatus, to the first apparatus; and when the first apparatus receives the coin information and the transaction identification information from the second apparatus, the first apparatus transmitting the coin information and customer identification information for identifying a customer associated with the transaction identification information, to the banking server.

According to the present invention, it is possible to, when an apparatus that cannot independently transmit coin information regarding coins handled by the apparatus to a banking server is caused to handle coins, enable transmission of coin information to the banking server without having to make significant system modifications.

### BRIEF DESCRIPTION OF THE DRAWINGS

FIG. 1 is a diagram showing an example of the overall configuration of a money handling system according to an embodiment;

FIG. 2 is a block diagram showing an example of the functional configuration of a money handling apparatus according to a first embodiment;

FIG. 3 is a block diagram showing an example of the functional configuration of a coin handling apparatus according to the first embodiment;

FIG. 4A is a sequence diagram showing an example of the operation of a money handling system according to the first embodiment;

FIG. 4B is a sequence diagram showing the example of the operation of the money handling system according to the first embodiment;

FIG. 5 is a block diagram showing an example of the functional configuration of a money handling apparatus according to a second embodiment;

FIG. 6 is a block diagram showing an example of the functional configuration of a coin handling apparatus according to the second embodiment;

FIG. 7A is a sequence diagram showing an example of the operation of a money handling system according to the second embodiment; and

FIG. 7B is a sequence diagram showing the example of the operation of the money handling system according to the second embodiment.

### DESCRIPTION OF THE PREFERRED EMBODIMENTS

Hereinafter, embodiments of the present invention will be described in detail with reference to the accompanying drawings.

### Background and Outline of Embodiment

An embodiment relates to a money handling system including a first apparatus configured to handle at least coins, and a second apparatus configured to handle coins and unable to independently transmit coin information regarding coins handled by the second apparatus to a banking server.

In the money handling system, for example, it is assumed that, if a large amount of coins are inserted into the first apparatus, the first apparatus becomes non-operational immediately due to becoming full of coins. In such a case, for example, if the second apparatus capable of handling a large amount of coins is added to the first apparatus, even if a large amount of coins are inserted into the first apparatus, the first apparatus does not become full of coins, and the operating time can be extended. However, for example, if the first apparatus is connected online to the banking server to perform real-time transactions, and if real-time transactions are to be performed for depositing to the second apparatus, the system becomes very complicated.

Therefore, in the present embodiment, the money handling system includes an output apparatus configured to output transaction identification information for identifying a coin transaction in the second apparatus, the second apparatus is configured to transmit coin information and the transaction identification information outputted by the output apparatus, to the first apparatus, and the first apparatus is configured to transmit the coin information and customer identification information for identifying a customer associated with the transaction identification information, to the banking server when the first apparatus receives the coin information and the transaction identification information from the second apparatus.

Here, the first apparatus may be an apparatus that handles banknotes in addition to coins. Thus, a description will be given below with a money handling apparatus that handles banknotes and coins as an example of the first apparatus.

In addition, the second apparatus may be an apparatus that handles only coins. Thus, a description will be given below with a coin handling apparatus that handles only coins as an example of the second apparatus.

Furthermore, the output apparatus may be a code processing apparatus that processes a code for identifying a coin transaction in the coin handling apparatus.

### [Overall Configuration of Money Handling System]

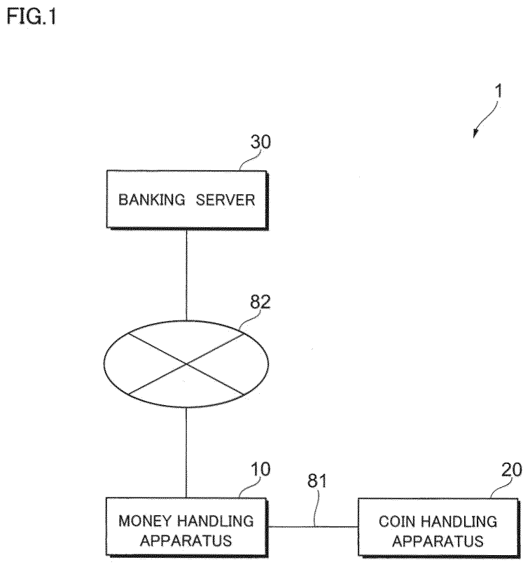

FIG. 1 is a diagram showing an example of the overall configuration of a money handling system 1 according to the present embodiment. As shown in the drawing, the money handling system 1 includes a money handling apparatus 10, a coin handling apparatus 20, and a banking server 30. The money handling apparatus 10 and the coin handling apparatus 20 are connected via a communication line 81, and the money handling apparatus 10 and the banking server 30 are connected via a communication line 82.

The money handling apparatus 10 is a so-called self-service machine that allows customers to deposit and dispense banknotes and coins themselves. The money handling apparatus 10 is an online apparatus connected to the banking server 30 via the communication line 82. The money handling apparatus 10 can handle coins by itself, and can also handle coins together with the coin handling apparatus 20. The money handling apparatus 10 is an example of the first apparatus configured to handle at least coins.

The coin handling apparatus 20 is a so-called coin handling machine that can deposit and dispense coins. The coin handling apparatus 20 is added to the money handling apparatus 10 in order to handle a large amount of coins that cannot be handled by the money handling apparatus 10. The coin handling apparatus 20 is a non-online apparatus that is not connected to the banking server 30 via a communication line. The second handling apparatus 20 is, by itself, unable to transmit coin information regarding coins handled by the second handling apparatus 20 to the banking server 30. Alternatively, the coin handling apparatus 20 may be an apparatus that cannot independently transmit coin information regarding coins handled by the apparatus, to the banking server 30, regardless of whether or not the apparatus is connected to the banking server 30 via a communication line. That is, the coin handling apparatus 20 may be an apparatus that does not have a function of independently transmitting coin information regarding coins handled by the apparatus, to the banking server 30. A plurality of coin handling apparatuses 20 may be added to the money handling apparatus 10. The coin handling apparatus 20 is an example of the second apparatus unable to independently transmit coin information regarding coins handled by the apparatus, to the banking server.

The banking server 30 is a server computer of a bank that performs a process of reflecting an amount of banknotes and coins deposited or dispensed by a customer, in an account of the customer.

The communication line 81 is a communication means for transmitting and receiving information between the money handling apparatus 10 and the coin handling apparatus 20. The communication line 81 may be, for example, a LAN (Local Area Network) or a USB (Universal Serial Bus).

The communication line 82 is a communication means for transmitting and receiving information between the money handling apparatus 10 and the banking server 30. The communication line 82 may be, for example, the Internet.

The above-described code processing apparatus is not shown in FIG. 1. This is because the code processing apparatus may be a separate apparatus but is generally present within the money handling apparatus 10 or the coin handling apparatus 20. Therefore, hereinafter, the case where the code processing apparatus is a code processing unit within the money handling apparatus 10 will be described as a first embodiment, and the case where the code processing apparatus is a code processing unit within the coin handling apparatus 20 will be described as a second embodiment.

### First Embodiment

### (Configuration of Money Handling Apparatus)

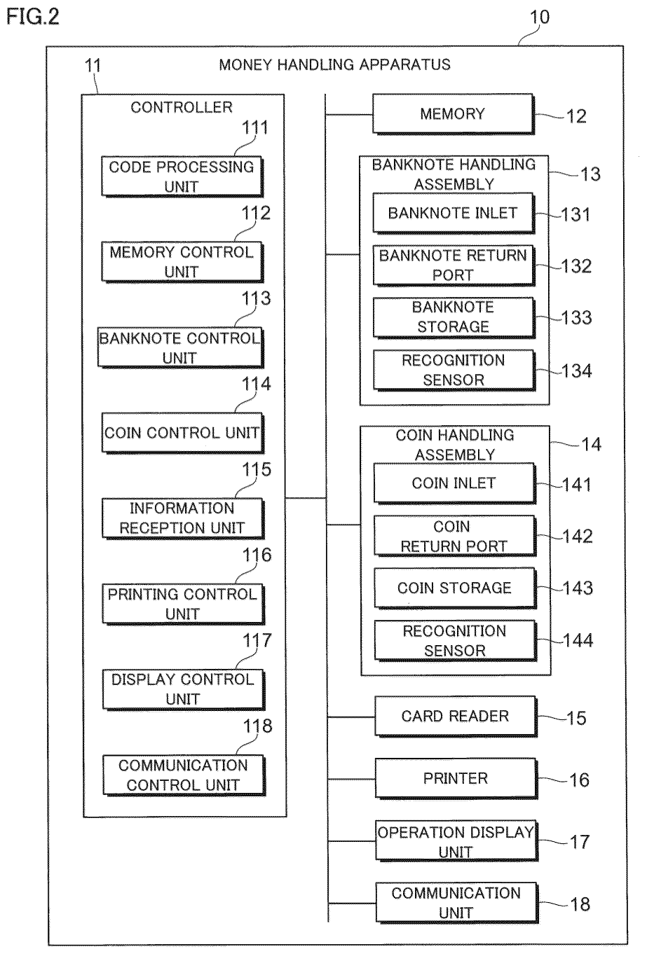

FIG. 2 is a block diagram showing an example of the functional configuration of a money handling apparatus 10 according to the first embodiment. As shown in the drawing, the money handling apparatus 10 according to the first embodiment includes a controller 11, a memory 12, a banknote handling assembly 13, a coin handling assembly 14, a card reader 15, a printer 16, an operation display unit 17, and a communication unit 18.

The controller 11 includes an arithmetic circuit such as a CPU (Central Processing Unit), and controls each component of the money handling apparatus 10 in accordance with an operation program stored in the memory 12.

The memory 12 includes a ROM (Read Only Memory), a RAM (Random Access Memory), etc., stores the operation program for the controller 11 therein, and is also used as a work area during the control process of the controller 11. The operation program includes a program for the controller 11 to execute processes described below.

The banknote handling assembly 13 is an assembly that performs a banknote handling process for banknotes. Specifically, the banknote handling assembly 13 transports banknotes inserted through a banknote inlet 131, and stores the banknotes in a banknote storage 133. In addition, the banknote handling assembly 13 performs authentication or the like on banknotes with a recognition sensor 134 and returns banknotes that cannot be accepted, to a banknote return port 132, or takes out banknote change from the banknote storage 133 and dispenses the banknote change to the banknote return port 132. Here, the banknote storage 133 may include a plurality of storages for storing banknotes of a plurality of denominations, respectively. The banknote handling assembly 13 is an example of a means for further handling banknotes.

The coin handling assembly 14 is an assembly that performs a coin handling process for coins. Specifically, the coin handling assembly 14 transports coins inserted through a coin inlet 141 and stores the coins in a coin storage 143. In addition, the coin handling assembly 14 performs authentication or the like on coins with a recognition sensor 144 and returns coins that cannot be accepted, to a coin return port 142, or takes out coin change from the coin storage 143 and dispenses the coin change to the coin return port 142. Here, the coin storage 143 may include a plurality of storages for storing coins of a plurality of denominations, respectively. The coin storage 143 is an example of a first coin storage unit configured to store coins. In addition, the coin handling assembly 14 is an example of a means for handling coins.

The card reader 15 is a reading device that reads information from a card. An example of the card is a cash card. When the customer logs in to the money handling apparatus 10 by passing the card through the card reader 15, the card reader 15 reads login information for identifying the customer, from the card as in the case of an ATM (Automatic Teller Machine). Alternatively, biometric information, QR codes (registered trademark), NFC (Near Field Communication), etc., may be used for the login to the money handling apparatus 10, but in the following, a description will be given assuming that the login is performed using a card.

The printer 16 prints various kinds of information on paper which is an example of a medium. As the paper, for example, roll paper is used.

The operation display unit 17 is a touch panel display, for example, and receives operations by a user and displays various kinds of information. The operation display unit 17 is an example of a display unit.

The communication unit 18 transmits and receives information to and from the coin handling apparatus 20 via the communication line 81. In addition, the communication unit 18 transmits and receives information to and from the banking server 30 via the communication line 82. Furthermore, the communication unit 18 transmits and receives information to and from a mobile terminal (not shown) of the customer via a wireless communication line which is not shown. The communication unit 18 is an example of a transmitter.

Next, the configuration of the controller 11 will be specifically described. The controller 11 includes a code processing unit 111, a memory control unit 112, a banknote control unit 113, a coin control unit 114, an information reception unit 115, a printing control unit 116, a display control unit 117, and a communication control unit 118.

The code processing unit 111 processes a code for identifying a coin transaction in the coin handling apparatus 20. The code may be a geometric code, a character string code, or the like. Examples of the geometric code include QR codes (registered trademark) and barcodes. The code is an example of the transaction identification information for identifying a coin transaction in the second apparatus.

Specifically, the code processing unit 111 generates a code, based on the login information read from the card by the card reader 15, and outputs this code to the printing control unit 116, the display control unit 117, and the communication control unit 118. This function of the code processing unit 111 is an example of the output apparatus configured to output the transaction identification information.

In addition, the code processing unit 111 extracts the login information from the code received from the coin handling apparatus 20 by the communication unit 18.

The memory control unit 112 controls writing of data to the memory 12 and reading of data from the memory 12.

The banknote control unit 113 performs control such that the banknote handling assembly 13 performs a banknote handling process. Then, the banknote control unit 113 acquires banknote information indicating the result of the banknote handling process by the banknote handling assembly 13. The banknote control unit 113 is an example of a means for acquiring banknote information regarding banknotes handled by the money handling apparatus 10.

The coin control unit 114 performs control such that the coin handling assembly 14 performs a coin handling process. Then, the coin control unit 114 acquires coin information indicating the result of the coin handling process by the coin handling assembly 14.

The information reception unit 115 receives information inputted by the customer.

Specifically, the information reception unit 115 receives the login information read from the card by the card reader 15. This function of the information reception unit 115 is an example of a means for receiving the customer identification information from the customer.

The information reception unit 115 also receives information based on operations performed by the customer on the operation display unit 17.

For example, if the customer selects a desired transaction on a transaction menu displayed on the operation display unit 17, the information reception unit 115 receives the transaction selection. At this time, if the information reception unit 115 receives selection of a coin-related transaction, the information reception unit 115 determines whether the transaction is to be processed using only the money handling apparatus 10 or using the coin handling apparatus 20. For example, if the customer presses a large amount coin depositing button on a depositing menu displayed on the operation display unit 17, the information reception unit 115 determines to perform handling using the coin handling apparatus 20.

Alternatively, the information reception unit 115 may determine whether to perform handling using only the money handling apparatus 10 or using the coin handling apparatus 20, without causing the customer to press the large amount coin depositing button.

For example, if the login information read from the card by the card reader 15 indicates that the customer is a corporation or is self-employed, the information reception unit 115 may determine to perform handling using the coin handling apparatus 20.

Also, if the login information read from the card by the card reader 15 indicates that the customer is an individual (general customer), the information reception unit 115 may determine that a coin handling process in the coin handling assembly 14 of the money handling apparatus 10 is allowed. On the other hand, if the login information read from the card by the card reader 15 indicates that the customer is not an individual (general customer), the information reception unit 115 may determine to perform handling using the coin handling apparatus 20.

However, in the following, a description will be given assuming that, if the customer presses the large amount coin depositing button, the information reception unit 115 determines to perform handling using the coin handling apparatus 20.

The printing control unit 116 controls the printer 16 to print information on paper.

Specifically, if the information reception unit 115 determines to perform handling using the coin handling apparatus 20, the printing control unit 116 controls the printer 16 to print the code generated by the code processing unit 111 on paper. This function of the printing control unit 116 is an example of a means for outputting the transaction identification information based on the customer identification information outputted by the output apparatus, to the customer. This function of the printing control unit 116 is also an example of a means for controlling a printer to print the transaction identification information on a medium.

The printing control unit 116 also controls the printer 16 to print a transaction statement regarding a series of transactions on paper after the money handling apparatus 10 transmits the login information, the banknote information, and the coin information to the banking server 30. This function of the printing control unit 116 is an example of a means for printing a transaction statement regarding a transaction on a medium after the coin information and the customer identification information are transmitted to the banking server.

The display control unit 117 controls display of information on the operation display unit 17.

Specifically, if the information reception unit 115 determines to perform handling using the coin handling apparatus 20, the display control unit 117 performs control so as to display information indicating a procedure for using the coin handling apparatus 20, on the operation display unit 17. Here, the information indicating the procedure for using the coin handling apparatus 20 includes, for example, guidance information for guiding the way to the coin handling apparatus 20 and information of an operation procedure on the coin handling apparatus 20. This function of the display control unit 117 is an example of a means for displaying a procedure for using the second apparatus.

For example, the display control unit 117 performs control so as to display the transaction menu on the operation display unit 17. In addition, if the customer presses a depositing transaction button on the transaction menu, the display control unit 117 performs control so as to display the depositing menu on the operation display unit 17. Furthermore, if the customer presses the large amount coin depositing button on the depositing menu, the display control unit 117 performs control so as to display the information indicating the procedure for using the coin handling apparatus 20, on the operation display unit 17. The large amount coin depositing button is an example of a specific selection item indicating coin depositing in the second apparatus, and this function of the display control unit 117 is an example of a means for displaying a transaction menu including the specific selection item, and displaying the procedure if the specific selection item is selected from the transaction menu.

Alternatively, the display control unit 117 may perform control so as to display the information indicating the procedure for using the coin handling apparatus 20, on the operation display unit 17, without causing the customer to press the large amount coin depositing button.

For example, if the login information read from the card by the card reader 15 indicates that the customer is a corporation or is self-employed, the display control unit 117 may perform control so as to display the information indicating the procedure for using the coin handling apparatus 20, on the operation display unit 17. This function of the display control unit 117 is an example of a means for displaying the procedure if the customer identification information indicates a corporation or self-employment.

Also, if the login information read from the card by the card reader 15 indicates that the customer is not an individual (general customer), the display control unit 117 may perform control so as to display the information indicating the procedure for using the coin handling apparatus 20, on the operation display unit 17. This function of the display control unit 117 is an example of a means for displaying the procedure if the customer identification information does not indicate a general customer.

However, in the following, a description will be given assuming that, if the customer presses the large amount coin depositing button, the display control unit 117 performs control so as to display the information indicating the procedure for using the coin handling apparatus 20, on the operation display unit 17.

In addition, if the information reception unit 115 determines that handling is to be performed using the coin handling apparatus 20, the display control unit 117 performs control so as to display the code generated by the code processing unit 111, on the operation display unit 17. This function of the display control unit 117 is an example of the means for outputting the transaction identification information based on the customer identification information outputted by the output apparatus, to the customer. This function of the display control unit 117 is also an example of a means for displaying the transaction identification information on the display unit.

The communication control unit 118 controls the communication unit 18 to transmit information to another device and receive information from another device.

Specifically, if the information reception unit 115 determines that handling is to be performed using the coin handling apparatus 20, the communication control unit 118 controls the communication unit 18 to transmit the code generated by the code processing unit 111 to the mobile terminal of the customer. This function of the communication control unit 118 is an example of the means for outputting the transaction identification information based on the customer identification information outputted by the output apparatus, to the customer. This function of the communication control unit 118 is also an example of a means for controlling the transmitter to transmit the transaction identification information to a mobile terminal.

The communication control unit 118 also receives a code and coin information from the coin handling apparatus 20. This function of the communication control unit 118 is an example of a means for receiving the coin information and the transaction identification information from the second apparatus.

Furthermore, the communication control unit 118 transmits login information and at least one of banknote information and coin information to the banking server 30 in association with each other. Here, the communication control unit 118 may use the login information extracted by the code processing unit 111 from the code received from the coin handling apparatus 20. In addition, the communication control unit 118 may use the banknote information acquired by the banknote control unit 113 from the banknote handling assembly 13. Furthermore, the communication control unit 118 may use the coin information received by the communication control unit 118 from the coin handling apparatus 20. This function of the communication control unit 118 is an example of a means for transmitting the coin information and customer identification information for identifying a customer associated with the transaction identification information, to the banking server when the coin information and the transaction identification information are received from the second apparatus. This function of the communication control unit 118 is an example of a means for transmitting the banknote information, the coin information, and the customer identification information to the banking server in association with each other.

In the above, the money handling apparatus 10 includes the banknote handling assembly 13 and the coin handling assembly 14, but may not necessarily include the banknote handling assembly 13. In this case, the money handling apparatus 10 may cause the coin handling apparatus 20 to handle coins without handling banknotes.

In addition, in the above, the money handling apparatus 10 includes the banknote handling assembly 13 and the coin handling assembly 14, but may further include a check handling assembly (not shown). In this case, the money handling apparatus 10 may cause the coin handling apparatus 20 to handle coins after handling banknotes and checks.

Also, the money handling apparatus 10 may include a coin-roll handling assembly (not shown).

Also, the money handling apparatus 10 may include a drop box (not shown) for inserting media that could not be accepted by the banknote handling assembly 13 and the coin handling assembly 14, or media placed in an envelope.

Furthermore, in the above, all of the printing control unit 116, the display control unit 117, and the communication control unit 118 output the code generated by the code processing unit 111, but the present invention is not limited to this. At least one of the printing control unit 116, the display control unit 117, and the communication control unit 118 may output the code generated by the code processing unit 111.

### (Configuration of Coin Handling Apparatus)

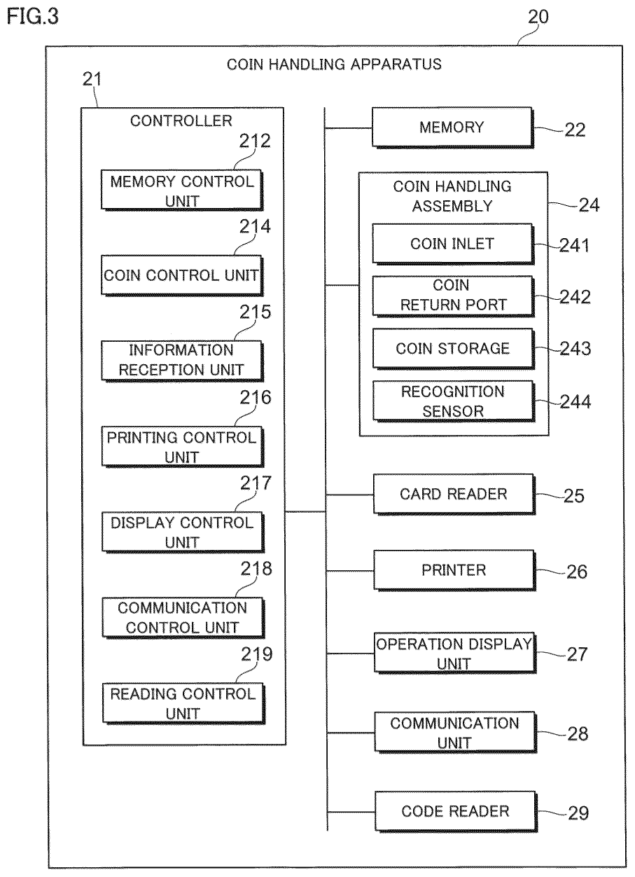

FIG. 3 is a block diagram showing an example of the functional configuration of a coin handling apparatus 20 according to the first embodiment. As shown in the drawing, the coin handling apparatus 20 according to the first embodiment includes a controller 21, a memory 22, a coin handling assembly 24, a card reader 25, a printer 26, an operation display unit 27, a communication unit 28, and a code reader 29.

The controller 21 includes an arithmetic circuit such as a CPU, and controls each component of the coin handling apparatus 20 in accordance with an operation program stored in the memory 22.

The memory 22 includes a ROM, a RAM, etc., stores the operation program for the controller 21 therein, and is also used as a work area during the control process of the controller 21. The operation program includes a program for the controller 21 to execute processes described below.

The coin handling assembly 24 is an assembly that performs a coin handling process for coins. Specifically, the coin handling assembly 24 transports coins inserted through a coin inlet 241 and stores the coins in a coin storage 243. In addition, the coin handling assembly 24 performs authentication or the like on coins with a recognition sensor 244 and returns coins that cannot be accepted, to a coin return port 242, or takes out coin change from the coin storage 243 and dispenses the coin change to the coin return port 242. Here, the coin storage 243 may have a larger storage capacity than the coin storage 143 of the money handling apparatus 10. In addition, the coin storage 243 may include a plurality of storages for storing coins of a plurality of denominations, respectively. In this case, each storage may have a larger storage capacity than the storage, for storing coins of the same denomination, in the coin storage 143 of the money handling apparatus 10. The coin storage 243 is an example of a second coin storage unit configured to store coins. In addition, the coin handling assembly 24 is an example of a means for handling coins.

The card reader 25 is a reading device that reads information from a card. An example of the card is a cash card. When the customer logs in to the coin handling apparatus 20 by passing the card through the card reader 25, the card reader 25 reads login information for identifying the customer, from the card as in the case of an ATM. In the present embodiment, the card reader 25 does not have to be provided, but is provided, for example, for the case where the customer uses only the coin handling apparatus 20.

The printer 26 prints various kinds of information on paper which is an example of a medium. As the paper, for example, roll paper is used. In the present embodiment, the printer 26 does not have to be provided, but is provided, for example, for the case where the customer uses only the coin handling apparatus 20.

The operation display unit 27 is a touch panel display, for example, and receives operations by a user and displays various kinds of information. The operation display unit 27 is an example of a display unit. In the present embodiment, the operation display unit 27 does not have to be provided, but is provided, for example, for the case where the customer uses only the coin handling apparatus 20.

The communication unit 28 transmits and receives information to and from the money handling apparatus 10 via the communication line 81. The communication unit 28 may transmit and receive information to and from the money handling apparatus 10 via a wire or wirelessly.

The code reader 29 reads codes from various media. Specifically, from paper having a code printed thereon or a screen of a mobile terminal on which a code is displayed, the code reader 29 reads the code.

Next, the configuration of the controller 21 will be specifically described. The controller 21 includes a memory control unit 212, a coin control unit 214, an information reception unit 215, a printing control unit 216, a display control unit 217, a communication control unit 218, and a reading control unit 219.

The memory control unit 212 controls writing of data to the memory 22 and reading of data from the memory 22.

The coin control unit 214 performs control such that the coin handling assembly 24 performs a coin handling process. Then, the coin control unit 214 acquires coin information indicating the result of the coin handling process by the coin handling assembly 24.

The information reception unit 215 receives information inputted by the customer.

Specifically, the information reception unit 215 receives the login information read from the card by the card reader 25.

The information reception unit 215 also receives information based on operations performed by the customer on the operation display unit 27.

The printing control unit 216 controls the printer 26 to print information on paper.

The display control unit 217 controls display of information on the operation display unit 27.

The communication control unit 218 controls the communication unit 28 to transmit information to another device and receive information from another device. Specifically, the communication control unit 218 transmits the code read by the code reader 29 and the coin information acquired by the coin control unit 214, to the money handling apparatus 10. Here, the code read by the code reader 29 is the code that is generated by the code processing unit 111 in the money handling apparatus 10, that is outputted by the printing control unit 116, the display control unit 117, and the communication control unit 118 to the customer, and that is held over the code reader 29 by the customer. The communication control unit 218 is an example of a means for transmitting the coin information and the transaction identification information outputted by the output apparatus, to the first apparatus.

The reading control unit 219 controls the code reader 29 to read a code from a medium. The reading control unit 219 is an example of a means for receiving the transaction identification information from the customer.

Specifically, the reading control unit 219 controls the code reader 29 such that, when the customer holds paper having a code printed thereon by the printer 16 in the money handling apparatus 10 over the code reader 29, the code reader 29 reads the code from the paper. Then, the reading control unit 219 acquires the code read from the paper by the code reader 29, and outputs the code to the communication control unit 218. This function of the reading control unit 219 is an example of a means for reading the transaction identification information printed on a medium.

Alternatively, the reading control unit 219 may control the code reader 29 such that, when the customer reads a code displayed on the operation display unit 17 in the money handling apparatus 10, with the camera of the mobile terminal, displays the code on the screen of the mobile terminal, and holds the code over the code reader 29, the code reader 29 reads the code from the screen of the mobile terminal. Then, the reading control unit 219 may acquire the code read from the screen of the mobile terminal by the code reader 29 and output the code to the communication control unit 218. This function of the reading control unit 219 is an example of a means for reading the transaction identification information displayed on a mobile terminal that has taken an image of the transaction identification information displayed on the display unit.

In addition, the reading control unit 219 may control the code reader 29 such that, when the customer displays a code received from the communication unit 18 in the money handling apparatus 10 on the screen of the mobile terminal and holds the code over the code reader 29, the code reader 29 reads the code from the screen of the mobile terminal. Then, the reading control unit 219 may acquire the code read from the screen of the mobile terminal by the code reader 29 and output the code to the communication control unit 218. This function of the reading control unit 219 is an example of a means for reading the transaction identification information displayed on the mobile terminal that has received the transaction identification information.

In the above, on the assumption that all of the printer 16, the operation display unit 17, and the communication unit 18 in the money handling apparatus 10 output codes, the reading control unit 219 reads all of the outputted codes, but the present invention is not limited to this. If at least one of the printer 16, the operation display unit 17, and the communication unit 18 in the money handling apparatus 10 outputs a code, the reading control unit 219 may read only the outputted code.

### (Operation of Money Handling System)

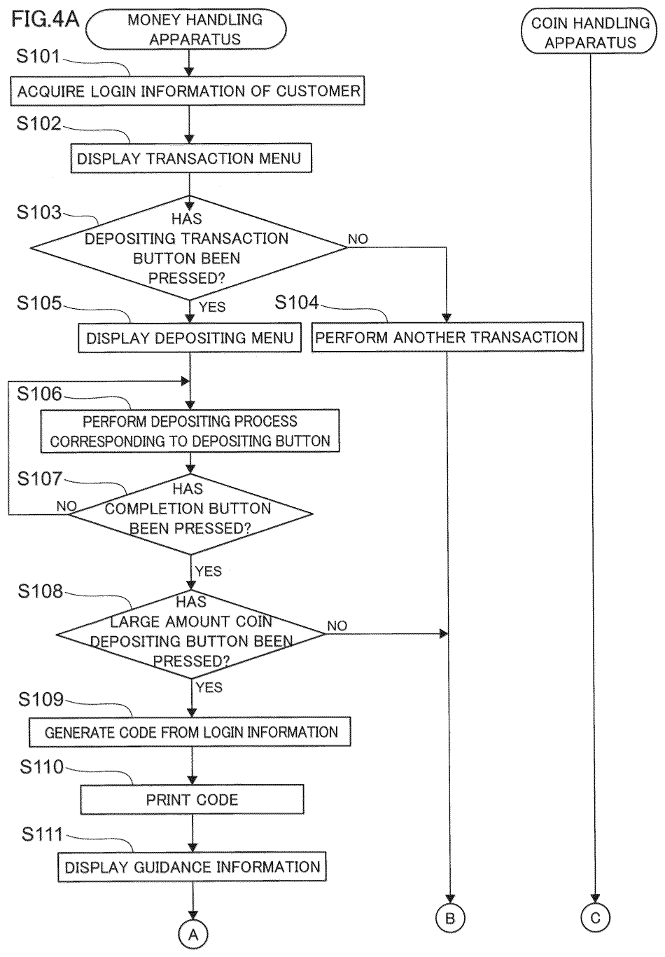

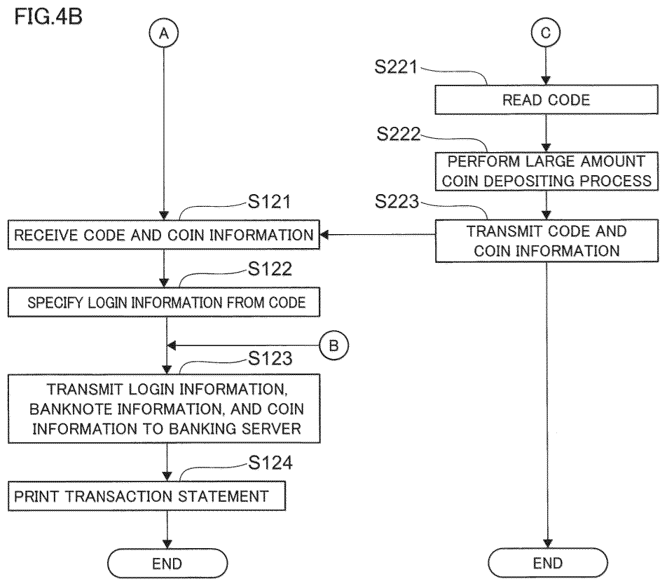

FIG. 4A and FIG. 4B are sequence diagrams showing an example of the operation of a money handling system 1 according to the first embodiment. In this example of the operation, a description will be given with the case where the printer 16 prints a code on paper as an example, but the same applies to the case where the operation display unit 17 displays a code and the case where the communication unit 18 transmits a code to the mobile terminal of the customer.

When the customer inserts the card into the card reader 15, as shown in FIG. 4A, in the money handling apparatus 10, the information reception unit 115 acquires the login information of the customer read from the card by the card reader 15 (step 101). Then, the display control unit 117 displays the transaction menu on the operation display unit 17 (step 102).

Next, the information reception unit 115 determines whether or not the depositing transaction button has been pressed on the transaction menu displayed on the operation display unit 17 (step 103).

If, in step 103, it is determined that the depositing transaction button has not been pressed, that is, it is determined that a transaction button other than the depositing transaction button has been pressed, the controller 11 performs another transaction corresponding to the other transaction button (step 104), and advances the process to step 123 in FIG. 4B.

On the other hand, if it is determined in step 103 that the depositing transaction button has been pressed, the display control unit 117 displays the depositing menu on the operation display unit 17 (step 105).

Next, the controller 11 performs a depositing process corresponding to a depositing button pressed on the depositing menu displayed on the operation display unit 17 (step 106). For example, if a banknote depositing button is pressed on the depositing menu, the banknote control unit 113 controls the banknote handling assembly 13 to perform a banknote depositing process of taking banknotes inserted by the customer, into the apparatus. At this time, the banknote control unit 113 acquires banknote information indicating the result of the banknote depositing process. In addition, if a small amount coin depositing button is pressed on the depositing menu, the coin control unit 114 controls the coin handling assembly 14 to perform a small amount coin depositing process of taking a small amount of coins inserted by the customer, into the apparatus. At this time, the coin control unit 114 acquires coin information indicating the result of the small amount coin depositing process. Here, the small amount coin depositing process is performed when the small amount coin depositing button is pressed, and this is merely a convenient expression described for the purpose of contrasting this small amount coin depositing process with a large amount coin depositing process used by the customer for the purpose of depositing a large amount of coins. Therefore, a coin depositing process that is generally performed by ATMs and coin handling apparatuses can also be performed as a small amount coin depositing process performed when the small amount coin depositing button is pressed. On the other hand, if the large amount coin depositing button is pressed on the depositing menu, the controller 11 does not perform any process at this time.

Next, the information reception unit 115 determines whether or not a completion button has been pressed on the depositing menu displayed on the operation display unit 17 (step 107).

If it is determined in step 107 that the completion button has not been pressed, the controller 11 returns the process to step 106.

On the other hand, if it is determined in step 107 that the completion button has been pressed, the information reception unit 115 determines whether or not the large amount coin depositing button has been pressed in step 106 (step 108).

If it is determined in step 108 that the large amount coin depositing button has not been pressed, the controller 11 advances the process to step 123 in FIG. 4B.

On the other hand, if it is determined in step 108 that the large amount coin depositing button has been pressed, the code processing unit 111 generates a code from the login information acquired in step 101 (step 109). In addition, the printing control unit 116 controls the printer 16 to print this code on paper (step 110). Furthermore, the display control unit 117 displays the guidance information for guiding the way to the coin handling apparatus 20, on the operation display unit 17 (step 111). Then, the controller 11 advances the process to step 121 in FIG. 4B.

Meanwhile, when the money handling apparatus 10 prints the code on paper and displays the guidance information for guiding the way to the coin handling apparatus 20 on the operation display unit 17 as in FIG. 4A, the customer receives the paper having the code printed thereon, and moves to the front of the coin handling apparatus 20 according to the guidance information. Then, when the customer holds this paper over the code reader 29 of the coin handling apparatus 20, as shown in FIG. 4B, in the coin handling apparatus 20, the reading control unit 219 controls the code reader 29 to read the code from the paper (step 221).

Next, when the customer inserts a large amount of coins into the coin handling apparatus 20, the coin control unit 214 controls the coin handling assembly 24 to perform a large amount coin depositing process of taking the inserted large amount of coins into the apparatus (step 222). At this time, the coin control unit 214 acquires coin information indicating the result of the large amount coin depositing process.

Then, the communication control unit 218 controls the communication unit 28 to transmit the code read in step 221 and the coin information acquired in step 222 to the money handling apparatus 10 (step 223).

Then, in the money handling apparatus 10, the communication control unit 118 controls the communication unit 18 to receive the code and the coin information from the coin handling apparatus 20 (step 121). Then, the code processing unit 111 specifies the login information of the customer from the code received in step 121 (step 122). Through step 121 and step 122, the customer and the coin information regarding the large amount coin depositing process in the coin handling apparatus 20 are associated with each other.

Next, the communication control unit 118 controls the communication unit 18 to transmit login information, banknote information, and coin information to the banking server 30 (step 123). Here, the login information is the information acquired in step 101 in FIG. 4A or the information specified in step 122. It is checked that the code generated in step 109 in FIG. 4A and the code received in step 121 match each other, so that the login information acquired in step 101 in FIG. 4A matches the login information specified in step 122. The banknote information is the information acquired when the banknote depositing process is performed in step 106 in FIG. 4A. The coin information is the information received from the coin handling apparatus 20 in step 121. However, the coin information may include the information acquired when the small amount coin depositing process is performed in step 106 in FIG. 4A.

Then, the printing control unit 116 controls the printer 16 to print a transaction statement regarding this series of depositing transactions on paper (step 124).

In FIG. 4A and FIG. 4B, it is assumed that one coin handling apparatus 20 is connected to one money handling apparatus 10, but when a plurality of coin handling apparatuses 20 are connected to one money handling apparatus 10, the controller 11 and the controller 21 may perform the following processes.

That is, if it is determined in step 108 that the large amount coin depositing button has been pressed, the controller 11 may specify a coin handling apparatus 20 by which a coin handling process is to be performed. For example, the controller 11 may select a coin handling apparatus 20 by which a coin handling process is to be performed, based on congestion information of the plurality of coin handling apparatuses 20.

In addition, the printing control unit 116 may include information on the coin handling apparatus 20 by which a coin handling process is to be performed, in the code to be printed on paper in step 110. For example, if the controller 11 selects a coin handling apparatus 20 by which a coin handling process is to be performed, based on the congestion information of the plurality of coin handling apparatuses 20, there is a higher possibility that information on a coin handling apparatus 20 other than a coin handling apparatus 20 to which the most recent customer was guided will be included in the code.

In addition, in step 111, the display control unit 117 may display guidance information including the information on the coin handling apparatus 20 by which a coin handling process is to be performed, on the operation display unit 17.

Furthermore, in step 221, the controller 21 may compare the information, on the coin handling apparatus 20 by which a coin handling process is to be performed, included in the code with the information for identifying the own apparatus, and if the comparison result is a match, the controller 21 may advance the process to step 222. On the other hand, if the comparison result is not a match, since the coin handling apparatus 20 is incorrect, the controller 21 may notify the user to perform handling using the correct coin handling apparatus 20, without advancing the process to step 222.

The example of the operation shown in the sequence diagrams of FIG. 4A and FIG. 4B is merely an example.

For example, after the process in step 111, the money handling apparatus 10 may shift to a logout state in which additional handling in the money handling apparatus 10 is not accepted. Then, the money handling apparatus 10 may be able to communicate with the coin handling apparatus 20 even in the logout state, and may continue to perform the processes in steps 221 to 223 and steps 121 to 124.

### Effects

In the present embodiment, in the money handling system 1 including the money handling apparatus 10 and the coin handling apparatus 20, the money handling apparatus 10 generates a code that can be read by the coin handling apparatus 20, and the coin handling apparatus 20 reads the code and performs a coin handling process.

Accordingly, depositing in the coin handling apparatus 20 can be reflected in an account as handling by the money handling apparatus 10, so that handling in a non-online apparatus can be treated like handling in an online apparatus.

Conventionally, it has been impossible to reflect depositing in the coin handling apparatus 20 as handling by the money handling apparatus 10 in an account, and even if such reflection is possible, manual processing has been required. However, it is made possible to automatically perform such reflection, thereby improving customer convenience.

In addition, it is no longer necessary to develop online functionality on the coin handling apparatus 20 side, making it possible to reduce the cost of introduction by a business operator.

### Second Embodiment

### (Configuration of Money Handling Apparatus)

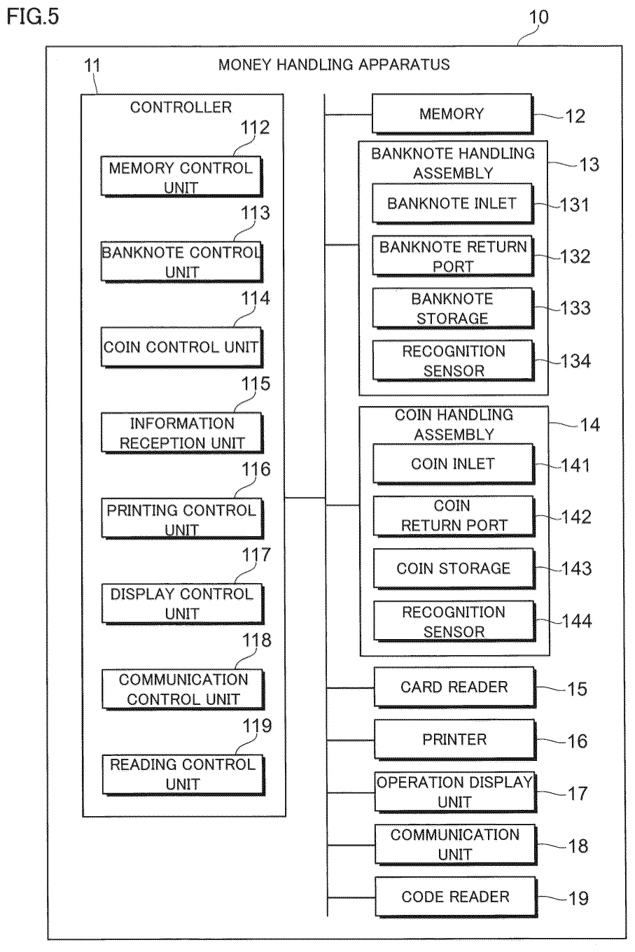

FIG. 5 is a block diagram showing an example of the functional configuration of a money handling apparatus 10 according to the second embodiment. As shown in the drawing, the money handling apparatus 10 according to the second embodiment includes a controller 11, a memory 12, a banknote handling assembly 13, a coin handling assembly 14, a card reader 15, a printer 16, an operation display unit 17, a communication unit 18, and a code reader 19.

The controller 11, the memory 12, the banknote handling assembly 13, the coin handling assembly 14, the card reader 15, the printer 16, and the operation display unit 17 are the same as in the first embodiment, and thus the description thereof is omitted.

The communication unit 18 transmits and receives information to and from the coin handling apparatus 20 via the communication line 81. In addition, the communication unit 18 transmits and receives information to and from the banking server 30 via the communication line 82.

The code reader 19 reads codes from various media. Specifically, from paper having a code printed thereon or a screen of a mobile terminal on which a code is displayed, the code reader 19 reads the code.

Next, the configuration of the controller 11 will be specifically described. The controller 11 includes a memory control unit 112, a banknote control unit 113, a coin control unit 114, an information reception unit 115, a printing control unit 116, a display control unit 117, a communication control unit 118, and a reading control unit 119.

The memory control unit 112, the banknote control unit 113, the coin control unit 114, and the information reception unit 115 are the same as in the first embodiment, and thus the description thereof is omitted.

The printing control unit 116 controls the printer 16 to print information on paper. Specifically, the printing control unit 116 controls the printer 16 to print a transaction statement regarding a series of transactions on paper after the money handling apparatus 10 transmits the login information, the banknote information, and the coin information to the banking server 30. This function of the printing control unit 116 is an example of the means for printing a transaction statement regarding a transaction on a medium after the coin information and the customer identification information are transmitted to the banking server.

The display control unit 117 controls display of information on the operation display unit 17. Specifically, if the information reception unit 115 determines to perform handling using the coin handling apparatus 20, the display control unit 117 performs control so as to display information indicating a procedure for using the coin handling apparatus 20, on the operation display unit 17. Here, the information indicating the procedure for using the coin handling apparatus 20 includes, for example, guidance information for guiding the way to the coin handling apparatus 20 and information of an operation procedure on the coin handling apparatus 20. This function of the display control unit 117 is an example of the means for displaying a procedure for using the second apparatus. The details of this function of the display control unit 117 are the same as in the first embodiment, and thus the description thereof is omitted.

The communication control unit 118 controls the communication unit 18 to transmit information to another device and receive information from another device.

Specifically, the communication control unit 118 receives a code and coin information from the coin handling apparatus 20. This function of the communication control unit 118 is an example of the means for receiving the coin information and the transaction identification information from the second apparatus.

In addition, the communication control unit 118 transmits login information, banknote information, and coin information to the banking server 30 in association with each other. Here, the communication control unit 118 may use the login information received by the information reception unit 115 from the card reader 15. In addition, the communication control unit 118 may use the banknote information acquired by the banknote control unit 113 from the banknote handling assembly 13. Furthermore, the communication control unit 118 may use the coin information received by the communication control unit 118 from the coin handling apparatus 20. This function of the communication control unit 118 is an example of the means for transmitting the coin information and customer identification information for identifying a customer associated with the transaction identification information, to the banking server when the coin information and the transaction identification information are received from the second apparatus. This function of the communication control unit 118 is an example of the means for transmitting the banknote information, the coin information, and the customer identification information to the banking server in association with each other.

The reading control unit 119 controls the code reader 19 to read a code from a medium. The reading control unit 119 is an example of the means for receiving the transaction identification information from the customer.

Specifically, the reading control unit 119 controls the code reader 19 such that, when the customer holds paper having a code printed thereon by a printer 26 in the coin handling apparatus 20 over the code reader 19, the code reader 19 reads the code from the paper. Then, the reading control unit 119 acquires the code read from the paper by the code reader 19. This function of the reading control unit 119 is an example of the means for reading the transaction identification information printed on a medium.

Alternatively, the reading control unit 119 may control the code reader 19 such that, when the customer reads a code displayed on an operation display unit 27 in the coin handling apparatus 20, with the camera of the mobile terminal, displays the code on the screen of the mobile terminal, and holds the code over the code reader 19, the code reader 19 reads the code from the screen of the mobile terminal. Then, the reading control unit 119 may acquire the code read from the screen of the mobile terminal by the code reader 19. This function of the reading control unit 119 is an example of the means for reading the transaction identification information displayed on a mobile terminal that has taken an image of the transaction identification information displayed on the display unit.

In addition, the reading control unit 119 may control the code reader 19 such that, when the customer displays a code received from a communication unit 28 in the coin handling apparatus 20 on the screen of the mobile terminal and holds the code over the code reader 19, the code reader 19 reads the code from the screen of the mobile terminal. Then, the reading control unit 119 may acquire the code read from the screen of the mobile terminal by the code reader 19. This function of the reading control unit 119 is an example of the means for reading the transaction identification information displayed on the mobile terminal that has received the transaction identification information.

In the above, the money handling apparatus 10 includes the banknote handling assembly 13 and the coin handling assembly 14, but may not necessarily include the banknote handling assembly 13. In this case, the money handling apparatus 10 may cause the coin handling apparatus 20 to handle coins without handling banknotes.

In addition, in the above, the money handling apparatus 10 includes the banknote handling assembly 13 and the coin handling assembly 14, but may further include a check handling assembly (not shown). In this case, the money handling apparatus 10 may cause the coin handling apparatus 20 to handle coins after handling banknotes and/or checks.

Furthermore, in the above, on the assumption that all of the printer 26, the operation display unit 27, and the communication unit 28 in the coin handling apparatus 20 output codes, the reading control unit 119 reads all of the outputted codes, but the present invention is not limited to this. If at least one of the printer 26, the operation display unit 27, and the communication unit 28 in the coin handling apparatus 20 outputs a code, the reading control unit 119 may read only the outputted code.

### (Configuration of Coin Handling Apparatus)

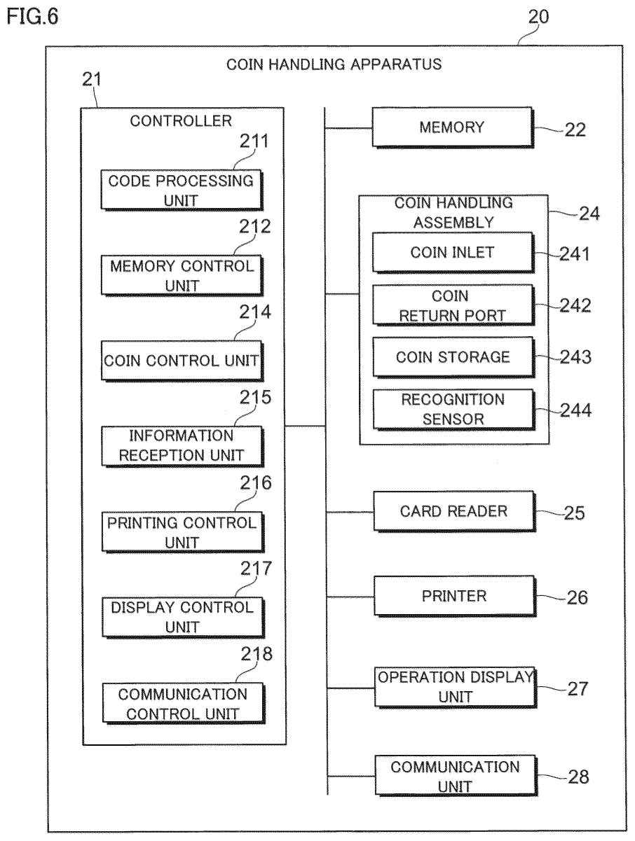

FIG. 6 is a block diagram showing an example of the functional configuration of a coin handling apparatus 20 according to the second embodiment. As shown in the drawing, the coin handling apparatus 20 according to the second embodiment includes a controller 21, a memory 22, a coin handling assembly 24, a card reader 25, a printer 26, an operation display unit 27, and a communication unit 28.

The controller 21, the memory 22, the coin handling assembly 24, and the card reader 25 are the same as in the first embodiment, and thus the description thereof is omitted.

The printer 26 and the operation display unit 27 are also the same as in the first embodiment, and thus the description thereof is omitted. However, in the present embodiment, the printer 26 and the operation display unit 27 need to be provided in order to output a code.

The communication unit 28 transmits and receives information to and from the money handling apparatus 10 via the communication line 81. In addition, the communication unit 28 transmits and receives information to and from a mobile terminal (not shown) of the customer via a wireless communication line which is not shown. The communication unit 28 may be a communication unit that supports Bluetooth (registered trademark), for example. The communication unit 28 is an example of the transmitter.

Next, the configuration of the controller 21 will be specifically described. The controller 21 includes a code processing unit 211, a memory control unit 212, a coin control unit 214, an information reception unit 215, a printing control unit 216, a display control unit 217, and a communication control unit 218.

The code processing unit 211 processes a code for identifying a coin transaction in the coin handling apparatus 20. The code may be a geometric code, a character string code, or the like. Examples of the geometric code include QR codes (registered trademark) and barcodes. The code is an example of the transaction identification information for identifying a coin transaction in the second apparatus. Specifically, the code processing unit 211 generates a random code and outputs this code to the printing control unit 216, the display control unit 217, and the communication control unit 218. The code processing unit 211 is an example of the output apparatus configured to output the transaction identification information.

The memory control unit 212, the coin control unit 214, and the information reception unit 215 are the same as in the first embodiment, and thus the description thereof is omitted.

The printing control unit 216 controls the printer 26 to print information on paper. Specifically, the printing control unit 216 controls the printer 26 to print the code generated by the code processing unit 211 on paper. This function of the printing control unit 216 is an example of a means for outputting the transaction identification information outputted by the output apparatus, to the customer. This function of the printing control unit 216 is also an example of the means for controlling a printer to print the transaction identification information on a medium.

The display control unit 217 controls display of information on the operation display unit 27. Specifically, the display control unit 217 performs control so as to display the code generated by the code processing unit 211, on the operation display unit 27. This function of the display control unit 217 is an example of the means for outputting the transaction identification information outputted by the output apparatus, to the customer. This function of the display control unit 217 is also an example of the means for displaying the transaction identification information on the display unit.

The communication control unit 218 controls the communication unit 28 to transmit information to another device and receive information from another device.

Specifically, the communication control unit 218 controls the communication unit 28 to transmit the code generated by the code processing unit 211 to the mobile terminal of the customer. This function of the communication control unit 218 is an example of the means for outputting the transaction identification information outputted by the output apparatus, to the customer. This function of the communication control unit 218 is also an example of a means for controlling the transmitter to transmit the transaction identification information to a mobile terminal.

In addition, the communication control unit 218 transmits the code generated by the code processing unit 211 and the coin information acquired by the coin control unit 214, to the money handling apparatus 10. This function of the communication control unit 218 is an example of the means for transmitting the coin information and the transaction identification information outputted by the output apparatus, to the first apparatus.

In the above, all of the printing control unit 216, the display control unit 217, and the communication control unit 218 output the code generated by the code processing unit 211, but the present invention is not limited to this. At least one of the printing control unit 216, the display control unit 217, and the communication control unit 218 may output the code generated by the code processing unit 211. In the case where the printing control unit 216 does not output a code, the printer 26 does not have to be provided, and in the case where the display control unit 117 does not output a code, the operation display unit 27 does not have to be provided.

### (Operation of Money Handling System)

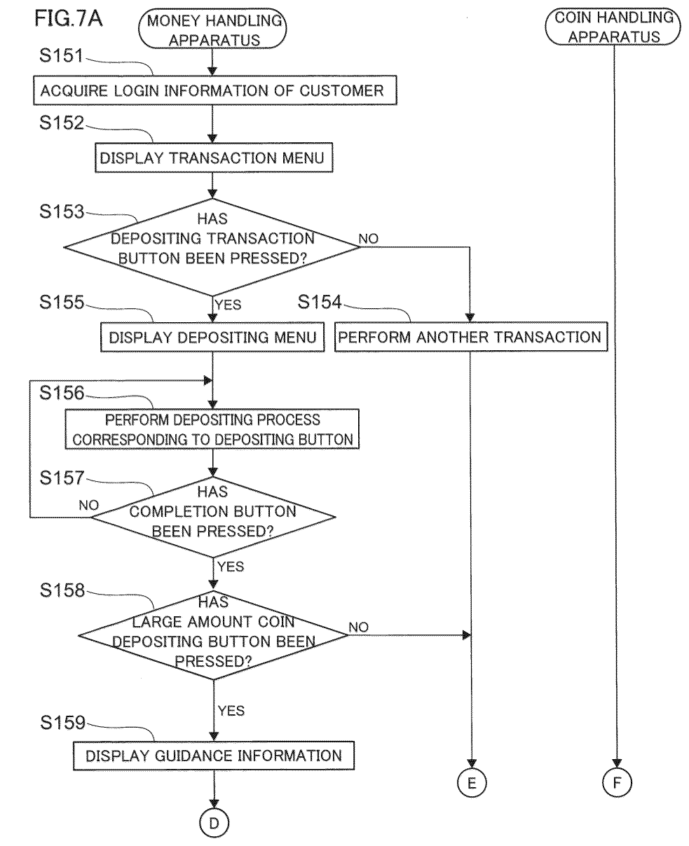

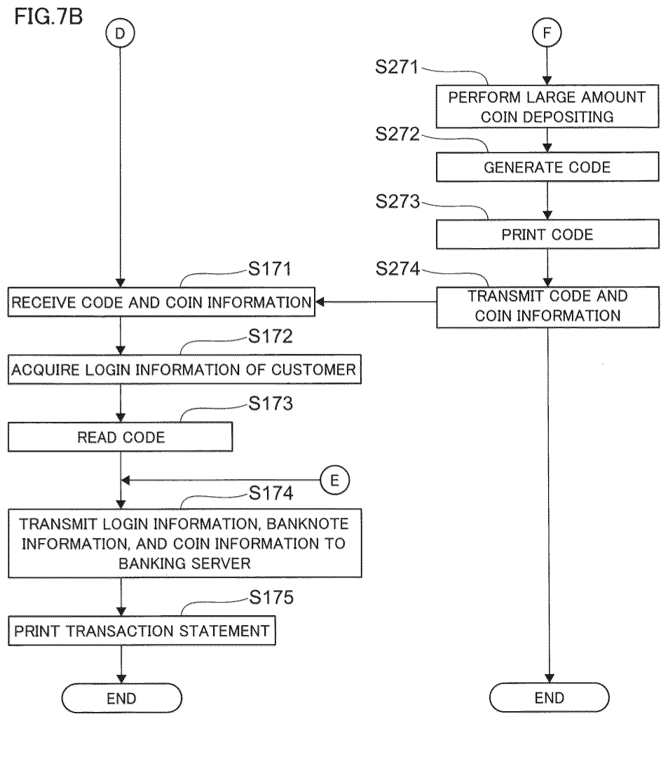

FIG. 7A and FIG. 7B are sequence diagrams showing an example of the operation of a money handling system 1 according to the second embodiment. In this example of the operation, a description will be given with the case where the printer 26 prints a code on paper as an example, but the same applies to the case where the operation display unit 27 displays a code and the case where the communication unit 28 transmits a code to the mobile terminal of the customer.

When the customer inserts the card into the card reader 15, as shown in FIG. 7A, in the money handling apparatus 10, the information reception unit 115 acquires the login information of the customer read from the card by the card reader 15 (step 151). Then, the display control unit 117 displays the transaction menu on the operation display unit 17 (step 152).

Next, the information reception unit 115 determines whether or not the depositing transaction button has been pressed on the transaction menu displayed on the operation display unit 17 (step 153).

If, in step 153, it is determined that the depositing transaction button has not been pressed, that is, it is determined that a transaction button other than the depositing transaction button has been pressed, the controller 11 performs another transaction corresponding to the other transaction button (step 154), and advances the process to step 174 in FIG. 7B.

On the other hand, if it is determined in step 153 that the depositing transaction button has been pressed, the display control unit 117 displays the depositing menu on the operation display unit 17 (step 155).

Next, the controller 11 performs a depositing process corresponding to a depositing button pressed on the depositing menu displayed on the operation display unit 17 (step 156). For example, if a banknote depositing button is pressed on the depositing menu, the banknote control unit 113 controls the banknote handling assembly 13 to perform a banknote depositing process of taking banknotes inserted by the customer, into the apparatus. At this time, the banknote control unit 113 acquires banknote information indicating the result of the banknote depositing process. In addition, if a small amount coin depositing button is pressed on the depositing menu, the coin control unit 114 controls the coin handling assembly 14 to perform a small amount coin depositing process of taking a small amount of coins inserted by the customer, into the apparatus. At this time, the coin control unit 114 acquires coin information indicating the result of the small amount coin depositing process. On the other hand, if the large amount coin depositing button is pressed on the depositing menu, the controller 11 does not perform any process at this time.

Next, the information reception unit 115 determines whether or not a completion button has been pressed on the depositing menu displayed on the operation display unit 17 (step 157).

If it is determined in step 157 that the completion button has not been pressed, the controller 11 returns the process to step 156.

On the other hand, if it is determined in step 157 that the completion button has been pressed, the information reception unit 115 determines whether or not the large amount coin depositing button has been pressed in step 156 (step 158).

If it is determined in step 158 that the large amount coin depositing button has not been pressed, the controller 11 advances the process to step 174 in FIG. 7B.

On the other hand, if it is determined in step 158 that the large amount coin depositing button has been pressed, the display control unit 117 displays the guidance information for guiding the way to the coin handling apparatus 20, on the operation display unit 17 (step 159). Then, the controller 11 advances the process to step 171 in FIG. 7B.

Meanwhile, when the money handling apparatus 10 displays the guidance information for guiding the way to the coin handling apparatus 20 on the operation display unit 17 as in FIG. 7A, the customer moves to the front of the coin handling apparatus 20 according to the guidance information. Then, when the customer inserts a large amount of coins into the coin handling apparatus 20, as shown in FIG. 7B, in the coin handling apparatus 20, the coin control unit 214 controls the coin handling assembly 24 to perform a large amount coin depositing process of taking the inserted large amount of coins into the apparatus (step 271). At this time, the coin control unit 214 acquires coin information indicating the result of the large amount coin depositing process. In this case, during a certain period of time after a certain customer ends handling with the money handling apparatus 10, the coin handling apparatus 20 may be in a state of being occupied by that customer such that the coin handling apparatus 20 cannot be used by other customers.

Next, the code processing unit 211 generates a code (step 272). At this time, the code processing unit 211 may generate a random code, for example. In addition, the printing control unit 216 controls the printer 26 to print this code on paper (step 273).

Then, the communication control unit 218 controls the communication unit 28 to transmit the code generated in step 272 and the coin information acquired in step 271 to the money handling apparatus 10 (step 274).

Then, in the money handling apparatus 10, the communication control unit 118 controls the communication unit 18 to receive the code and the coin information from the coin handling apparatus 20 (step 171). Meanwhile, when the coin handling apparatus 20 prints the code on paper in step 273, the customer receives the paper having the code printed thereon, and moves to the front of the money handling apparatus 10. Then, when the customer inserts the card into the card reader 15, the information reception unit 115 acquires the login information of the customer read from the card by the card reader 15 (step 172). In addition, when the customer holds the paper received at the coin handling apparatus 20 over the code reader 19 of the money handling apparatus 10, the reading control unit 119 controls the code reader 19 to read the code from the paper (step 173). Through steps 171 to 173, the customer and the coin information regarding the large amount coin depositing process in the coin handling apparatus 20 are associated with each other.

Next, the communication control unit 118 controls the communication unit 18 to transmit login information, banknote information, and coin information to the banking server 30 (step 174). Here, the login information is the information acquired in step 151 in FIG. 7A or the information acquired in step 172. The banknote information is the information acquired when the banknote depositing process is performed in step 156 in FIG. 7A. The coin information is the information received from the coin handling apparatus 20 in step 171. However, the coin information may include the information acquired when the small amount coin depositing process is performed in step 156 in FIG. 7A.

Then, the printing control unit 116 controls the printer 16 to print a transaction statement regarding this series of depositing transactions on paper (step 175).

The example of the operation shown in the sequence diagrams of FIG. 7A and FIG. 7B is merely an example.

For example, after the process in step 159, the money handling apparatus 10 may shift to a logout state in which additional handling in the money handling apparatus 10 is not accepted. Then, the money handling apparatus 10 may be able to communicate with the coin handling apparatus 20 even in the logout state, and may continue to perform the processes in steps 271 to 274 and steps 171 to 175.

### Modifications

In the above, as part of the depositing process performed earlier at the money handling apparatus 10 side, the large amount coin depositing process is performed later at the coin handling apparatus 20 side and a code is printed on paper, but the present invention is not limited to this. The large amount coin depositing process may be performed earlier at the coin handling apparatus 20 side and a code may be printed on paper, and this may be able to be treated as part of the depositing process performed later in the money handling apparatus 10.

### Effects

In the present embodiment, in the money handling system 1 including the money handling apparatus 10 and the coin handling apparatus 20, the coin handling apparatus 20 performs a coin handling process and generates a code that can be read by the money handling apparatus 10, and the money handling apparatus 10 reads the code.

Accordingly, depositing in the coin handling apparatus 20 can be reflected in an account as handling by the money handling apparatus 10, so that handling in a non-online apparatus can be treated like handling in an online apparatus.

Conventionally, it has been impossible to reflect depositing in the coin handling apparatus 20 as handling by the money handling apparatus 10 in an account, and even if such reflection is possible, manual processing has been required. However, it is made possible to automatically perform such reflection, thereby improving customer convenience.

In addition, it is no longer necessary to develop online functionality on the coin handling apparatus 20 side, making it possible to reduce the cost of introduction by a business operator.

### Modifications of Present Embodiments

Although not mentioned in the above embodiments, there may be cases where the coin information regarding the large amount coin depositing process in the coin handling apparatus 20 is not transmitted from the coin handling apparatus 20 to the money handling apparatus 10 or from the money handling apparatus 10 to the banking server 30 for some reason. In such a case, the coin handling apparatus 20 or the money handling apparatus 10 may retry transmission at a different time. In that case, the coin handling apparatus 20 or the money handling apparatus 10 may display this retry on a screen or print this retry on paper.

In addition, if the coin information regarding the large amount coin depositing process in the coin handling apparatus 20 is not transmitted even by retry, the coin handling apparatus 20 or the money handling apparatus 10 may print list information of un-deposited amounts to allow a deposited amount of money to be manually reflected in an account.

Furthermore, in the above embodiments, the coin information regarding the large amount coin depositing process in the coin handling apparatus 20 is all reflected in the account, but the present invention is not limited to this. Part of the coin information may be used for issuing electronic money or a coupon.

Furthermore, although not mentioned in the above embodiments, the coin handling apparatus 20 may be enabled to cooperate with an apparatus having an online function in addition to the money handling apparatus 10.

What is claimed is:

1. A coin handling system comprising:
a first apparatus configured to handle at least coins;
a second apparatus configured to handle coins and be, by itself, unable to transmit coin information regarding coins handled by the second apparatus, to a banking server; and
an output apparatus configured to output transaction identification information for identifying a coin transaction in the second apparatus, wherein
the second apparatus transmits the coin information and the transaction identification information outputted by the output apparatus, to the first apparatus, and
when the first apparatus receives the coin information and the transaction identification information from the second apparatus, the first apparatus transmits the coin information and customer identification information for identifying a customer associated with the transaction identification information, to the banking server.

2. The coin handling system according to claim 1, wherein
the first apparatus includes a first coin storage unit configured to store coins therein,
the second apparatus includes a second coin storage unit configured to store coins therein, and
the second coin storage unit has a larger storage capacity than the first coin storage unit.

3. The coin handling system according to claim 2, wherein
the first coin storage unit includes a plurality of storage units configured to store therein coins of a plurality of dominations, respectively,
the second coin storage unit includes a plurality of storage units configured to store therein coins of the plurality of dominations, respectively, and
each storage unit of the second coin storage unit has a larger storage capacity than the storage unit, of the first coin storage unit, configured to store therein coins of the same domination as in the each storage unit.

4. The coin handling system according to claim 1, wherein
the output apparatus is included in the first apparatus,
the first apparatus receives the customer identification information from the customer, and outputs the transaction identification information based on the customer identification information outputted by the output apparatus, to the customer, and
the second apparatus receives the transaction identification information from the customer.

5. The coin handling system according to claim 4, wherein
the first apparatus controls a printer to print the transaction identification information on a medium as an outputting of the transaction identification information to the customer, and
the second apparatus receiving the transaction identification information from the customer includes the second apparatus reading the transaction identification information printed on the medium.

6. The coin handling system according to claim 4, wherein
the first apparatus controls a display unit to display the transaction identification information on the display unit as an outputting of the transaction identification information to the customer, and
the second apparatus receiving the transaction identification information from the customer includes the second apparatus reading the transaction identification information displayed on a mobile terminal that has taken an image of the transaction identification information displayed on the display unit.

7. The coin handling system according to claim 4, wherein
the first apparatus controls a transmitter to transmit the transaction identification information to a mobile terminal as an outputting of the transaction identification information to the customer, and
the second apparatus receiving the transaction identification information from the customer includes the second apparatus reading the transaction identification information displayed on the mobile terminal that has received the transaction identification information.

8. The coin handling system according to claim 1, wherein
the output apparatus is included in the second apparatus,
the second apparatus outputs the transaction identification information outputted by the output apparatus, to the customer, and
the first apparatus receives the customer identification information and the transaction identification information from the customer.

9. The coin handling system according to claim 8, wherein
the second apparatus controls a printer to print the transaction identification information on a medium as an outputting of the transaction identification information to the customer, and
the first apparatus receiving the transaction identification information from the customer includes the first apparatus reading the transaction identification information printed on the medium.

10. The coin handling system according to claim 8, wherein
the second apparatus controls a display unit to display the transaction identification information on the display unit as an outputting of the transaction identification information to the customer, and
the first apparatus receiving the transaction identification information from the customer includes the first apparatus reading the transaction identification information displayed on a mobile terminal that has taken an image of the transaction identification information displayed on the display unit.

11. The coin handling system according to claim 8, wherein
the second apparatus controls a transmitter to transmit the transaction identification information to a mobile terminal as an outputting of the transaction identification information to the customer, and
the first apparatus receiving the transaction identification information from the customer includes the first apparatus reading the transaction identification information displayed on the mobile terminal that has received the transaction identification information.

12. The coin handling system according to claim 1, wherein the first apparatus prints a transaction statement regarding the transaction on a medium after transmitting the coin information and the customer identification information to the banking server.

13. The coin handling system according to claim 1, wherein the first apparatus displays a procedure for using the second apparatus.

14. The coin handling system according to claim 13, wherein the first apparatus displays a transaction menu including a specific selection item indicating coin depositing in the second apparatus, and displays the procedure if the specific selection item is selected from the transaction menu.

15. The coin handling system according to claim 13, wherein the first apparatus displays the procedure if the customer identification information indicates a corporation or self-employment.

16. The coin handling system according to claim 13, wherein the first apparatus displays the procedure if the customer identification information does not indicate a general customer.

17. The coin handling system according to claim 1, wherein the first apparatus further handles banknotes, acquires banknote information regarding banknotes handled by the first apparatus, and transmits the banknote information, the coin information, and the customer identification information to the banking server in association with each other.

18. The coin handling system according to claim 1, wherein the transaction identification information is a geometric code or a character string code.

19. The coin handling system according to claim 18, wherein the geometric code is a QR code.

20. A coin handling method in a coin handling system including
a first apparatus configured to handle at least coins,
a second apparatus configured to handle coins and be, by itself, unable to transmit coin information regarding coins handled by the second apparatus, to a banking server, and
an acquisition apparatus configured to acquire transaction identification information for identifying a coin transaction in the second apparatus, the coin handling method comprising:
the second apparatus transmitting the coin information and the transaction identification information acquired by the acquisition apparatus, to the first apparatus; and
when the first apparatus receives the coin information and the transaction identification information from the second apparatus, the first apparatus transmitting the coin information and customer identification information for identifying a customer associated with the transaction identification information, to the banking server.
